(19) United States
(12) Patent Application Publication
(10) Pub. No.: US 2011/0143886 A1
(43) Pub. Date: Jun. 16, 2011

(54) ROLLER, USAGE THEREOF AND TREADMILL USING THE SAME

(75) Inventor: Sheng Ju Zheng, Wenquan Town (CN)

(73) Assignee: DONGGUAN CHANGTAI HARDWARE PRODUCTS CO., LTD., Dongguan City (CN)

(21) Appl. No.: 12/964,444

(22) Filed: Dec. 9, 2010

(30) Foreign Application Priority Data
Dec. 16, 2009 (CN) 200910259214.X

(51) Int. Cl. A63B 22/02; A01B 29/00

(52) U.S. Cl. 482/54; 492/28

(57) ABSTRACT

Disclosed herein are a roller, a method for using the roller, and a treadmill incorporating the roller. The roller may be integrally structured and have a pipe wall thickness at intermediate portion less than a pipe wall thickness at an end portion, and towards the end portion, a pipe wall size at the intermediate portion transited into a pipe wall size at the end portion. The roller can serve as a transmission member and may be used in a treadmill.

### CROSS-REFERENCE TO RELATED APPLICATIONS

This application claims priority to Chinese Patent Application No. 200910259214.X, filed Dec. 16, 2009, which is incorporated herein by reference in its entirety.

### BACKGROUND

1. Technical Field

The present disclosure relates to a roller serving as a transmission member, the usage of the roller and a treadmill using the roller.

2. Description of Related Art

As shown in FIG. 3, most of the existing rollers serving as a transmission member are cylindrical pipes with identical pipe wall thickness.

Conventionally, a treadmill mainly comprises a roller, a roller power input means, a movement transmission means and a frame body. When a person stands on the roller of the treadmill for running exercise, power is inputted from the roller power input means to drive the movement transmission means to move.

Conventionally, the roller of the treadmill is constructed as shown in FIGS. 11-13. A roller 10 with an internal embedded iron sleeve as shown in FIG. 11 comprises a steel pipe 2 and an internal embedded iron sleeve 101 embedded in both ends of the steel pipe. When being manufactured, a section of internal embedded iron sleeve 101 is embedded in the inner surface of the steel pipe, such that the iron sleeve achieves the object of fastening a bearing. Since the roller is comprised of two parts, not only the processes are complicated, but also the materials are subject to waste. In the case of longtime rotation, the iron sleeve 101 and the steel pipe 2 gradually become loose because of the internal embedded iron sleeve 101 gets hot after squeezing the bearing for a longtime, whereby a fitting gap between the steel pipe 2 and the internal embedded iron sleeve 101 is broadened and thus the service life of the roller is reduced. To solve this problem, the roller 14 with a cap iron sleeve, as shown in FIG. 12, is available on the market, wherein such roller is provided with cap iron sleeves 141 at two ends of the steel pipe 2. Although the problem can be solved, there still might be the problems of requiring too many manufacturing processes and wasting too many materials. FIG. 13 shows an integral-type thick wall 15, which directly uses a steel pipe with a thicker pipe wall as a roller, and the steel pipe 2 is further processed to have bearing bores for seating the bearing by a turning tool. Manufacture of such roller needs fewer processes and brings about good effect; however, it wastes too many materials.

### SUMMARY OF THE INVENTION

According to one aspect of the present disclosure, a roller that is integrally structured has a pipe wall thickness at an intermediate portion thereof less than a pipe wall thickness at an end portion thereof, and towards the end portion, a pipe wall size at the intermediate portion transits into a pipe wall size at the end portion.

In one embodiment, the pipe wall thickness has an evenness of ±0.03 mm and a straightness less than or equal to 0.08 mm, and outer diameter of the pipe wall has an ellipticity of ±0.015 mm.

The pipe wall thickness has an evenness of ±0.01 mm and a straightness of 0.05, and the outer diameter has an ellipticity of ±0.005 mm.

A transition section where pipe wall thickness size at the intermediate portion transits towards the end portion into pipe wall thickness size at the end portion is in a conical shape.

A transition section where the pipe wall thickness size at the intermediate portion transits towards the end portion into the pipe wall thickness size at the end portion is in an arc shape.

The roller can serve as a transmission member.

The transmission member is a roller for a treadmill.

A treadmill using the roller comprises a roller, a roller power input means, a movement transmission means and a frame body, and the roller that is integrally structured has a pipe wall thickness at an intermediate portion that is less than a pipe wall thickness at an end portion, and towards the end portion, a pipe wall size at the intermediate portion transitioned into a pipe wall size at the end portion.

The pipe wall thickness of the roller of the treadmill has an evenness of ±0.03 mm and a straightness less than or equal to 0.08 mm, and the outer diameter of the pipe wall has an ellipticity of ±0.015 mm.

The present disclosure brings about the following advantageous effects:

1. The present disclosure utilizes a drawing process and an extruding die to process the steel pipe as shown in FIG. 3 into the roller as shown in FIGS. 1-2, and compared with the roller in FIGS. 11 and 12, such roller is of a simple structure, and the end portion thereof have high strength and may not easily to be deformed due to its integral structure, and thus the roller has a longer service life.

2. The present disclosure draws a steel pipe with a thin thickness into the roller as shown in FIGS. 1 and 2, which as compared with FIG. 13, saves more materials, particularly 30%, needs fewer processes and thus achieves a lower cost.

3. When the pipe wall thickness has an evenness of ±0.03 mm and a straightness less than or equal to 0.08 mm, and the external diameter of the pipe wall has an ellipticity of ±0.015 mm, the roller can serve as a transmission member, wherein such roller, compared with a roller serving as a support member with evenness of the pipe wall thickness and straightness of the pipe wall and ellipticity of the outer diameter of the pipe wall out of the above value range, e.g., a bicycle frame, can achieve a better dynamic balance, that is, keeping balance during transmission. If the roller serving as a support member is used for transmission, and it will result in unbalanced movement, which cannot bring about the effect of keeping dynamic balance without lathing its outer diameter and frequentative adjustment.

### BRIEF DESCRIPTION OF THE DRAWINGS

FIG. 1 is a cross-section view of one embodiment of a roller;

FIG. 2 is a cross-section view of another embodiment of a roller;

FIG. 3 is a steel pipe that is to be processed into a roller;

FIG. 4 is a schematic viewing of the process of machining a necking at an end portion of the steel pipe as shown in FIG. 3;

FIG. 5 is a steel pipe with the necking machined as shown in FIG. 4;

FIG. 6 is a schematic viewing of thickening an end portion of the steel pipe as shown in FIG. 5 and thinning an intermediate portion of the same steel pipe;

FIG. 7 is the steel pipe processed as shown in FIG. 6;

FIG. 8 is a schematic viewing of processing a tail end of the steel pipe as shown in FIG. 7;

FIG. 9 is the steel pipe processed in the process as shown in FIG. 8;

FIG. 10 is a treadmill using a roller;

FIG. 11 is a roller with an internal embedded iron sleeve;

FIG. 12 is a roller with a cap iron sleeve; and

FIG. 13 is an integral-type roller with a thicker pipe wall;

In the drawings, the following reference numerals are used: 1. integral-type roller; 11. intermediate portion; 12. end portion; 13. transition section; 2. crude steel pipe; 3. crude steel pipe necking processing tool; 31. die for processing the necking; 311. groove; 32. die for pressing the intermediate portion; 33. die for supporting the rear end of the end portion; 4. necked steel pipe; 5. die for drawing; 51. die for extruding the necking; 52. die for thinning and extruding the steel pipe intermediate portion; 53. die for forming the transition section; 6. drawn product; 61. tail end; 7. die for processing the tail end; 71. die for extruding the tail end; 72. die for pushing; 8. shaped semi-finished product; 9. pipe cutting machine; 10. roller with internal embedded iron sleeves; 101. internal embedded iron sleeve; 14. roller with cap iron sleeves; 141. cap iron sleeve; 15. integral-type thick wall roller.

### DETAILED DESCRIPTION

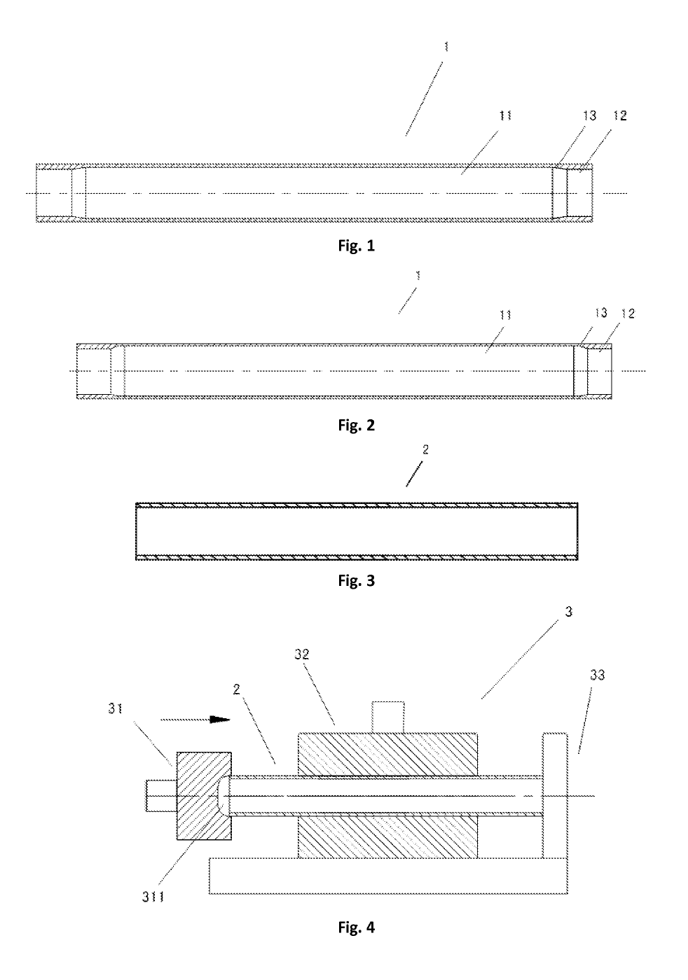

Referring to FIG. 1, according to one embodiment, an integral-type roller 1 has integral structure, and the pipe wall thickness at the intermediate portion 11 thereof is thinner than the pipe wall thickness at the end portion 12 thereof. Towards the end portion 12, the pipe wall size at the intermediate portion 11 transits into the pipe wall size at the end portion 12, and a transition section 13 where the size of the pipe wall thickness at the intermediate portion 11 transited into the size of the pipe wall thickness at the end portion 12 is in a conical shape. The pipe wall thickness at the intermediate portion 11 is 0.25-5 mm less than the pipe wall thickness at the end portion 12. The pipe wall thickness of the above roller has an evenness of ±0.03 mm and a straightness less than or equal to 0.08 mm, and the outer diameter of the pipe wall has an ellipticity of ±0.015 mm. It, as proved by experiments, brings about the best dynamic balance effect of transmission when the pipe wall thickness has an evenness of ±0.01 mm and a straightness of 0.05, and the outer diameter has an ellipticity of ±0.005 mm.

In alternative embodiment, as shown in FIG. 2, the transition section 13 has an arc shape.

As illustrated in FIG. 3, the raw material of the present roller may be a steel pipe 2 with an identical inner diameter.

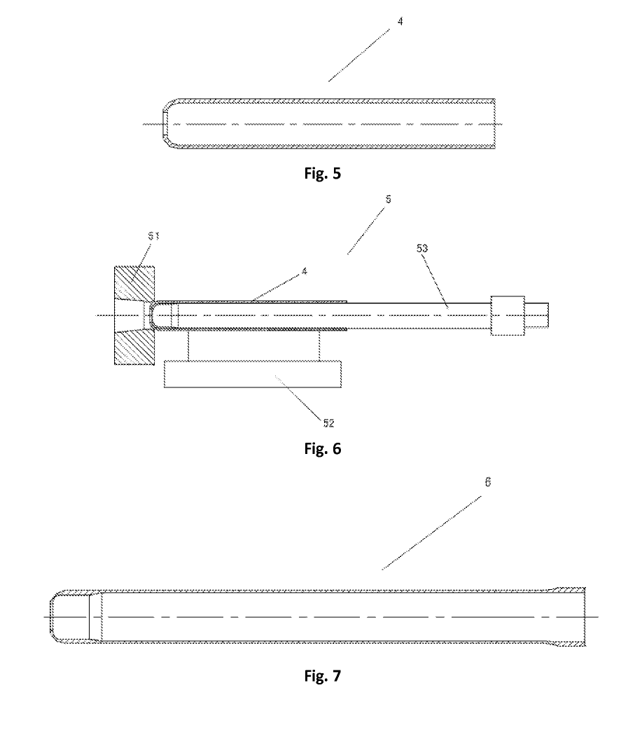

Referring to FIG. 4, a set of raw material necking processing tool 3 may be used herein for processing the steel pipe 2 as shown in FIG. 3 to have an arc-shaped necking, wherein the tool comprises a die for processing the necking 31 that is used to process the front end of the steel pipe into a necking, a die for pressing the steel pipe 32 that is used to hold the steel pipe stationary during extrusion and a die for supporting the rear end of the end portion 33. Before processed to have a necking, the steel pipe 2 is annealed at a temperature of 650 degrees and applied with smooth surface film treatment. The steel pipe 2 is placed in the die for processing the intermediate portion 32, and while one end of the steel pipe 2 abuts against the die for supporting rear end of end portion 33, the groove 311 of the die for processing the necking 31 is aligned with the other end of the steel pipe 2 and extrusion is started to process the end portion 12 of the steel pipe 2 to have an arc shape, as shown in FIG. 5.

Referring to FIG. 6, in one embodiment, after completion of processing the necking of the steel pipe 2, a die for drawing 5 is used to process the necked steel pipe 4 of FIG. 5 into the pipe as shown in FIG. 7. The die for drawing 5 comprises a die for extruding the front end 51, a die for thinning and extruding the steel pipe intermediate portion 52 and a die for forming the transition section 53; the die for extruding the front end 51 cooperates with the die for forming the transition section 53 such that a front end of the necked steel pipe 4 is extruded by the die for extruding the front end 51 so as to move inward in the diameter direction and meanwhile the die for forming the transition section 53 extrudes the front end of the necked steel pipe 4 outward in the diameter direction. Since the portion that acts against the front end of the steel pipe of the die 53 is shaped to have a gradually increased inner diameter size, the front end of the steel pipe, under the cooperation of the die for extruding the front end 51 and the die for forming the transition section 53, is processed to have a shape the same as that of the front end of the steel pipe shown in FIG. 7. The die for thinning and extruding the steel pipe intermediate portion 52 extrudes the pipe body of the necked steel pipe 4 so as to make the pipe body thinner, as shown in FIG. 7.

In one embodiment, as shown in FIG. 7, the die for drawing 6 in FIG. 6 draws the steel pipe 2 to obtain the drawn product 6, and the front end and the rear end thereof do not get thinner and while the intermediate portion thereof gets thinner.

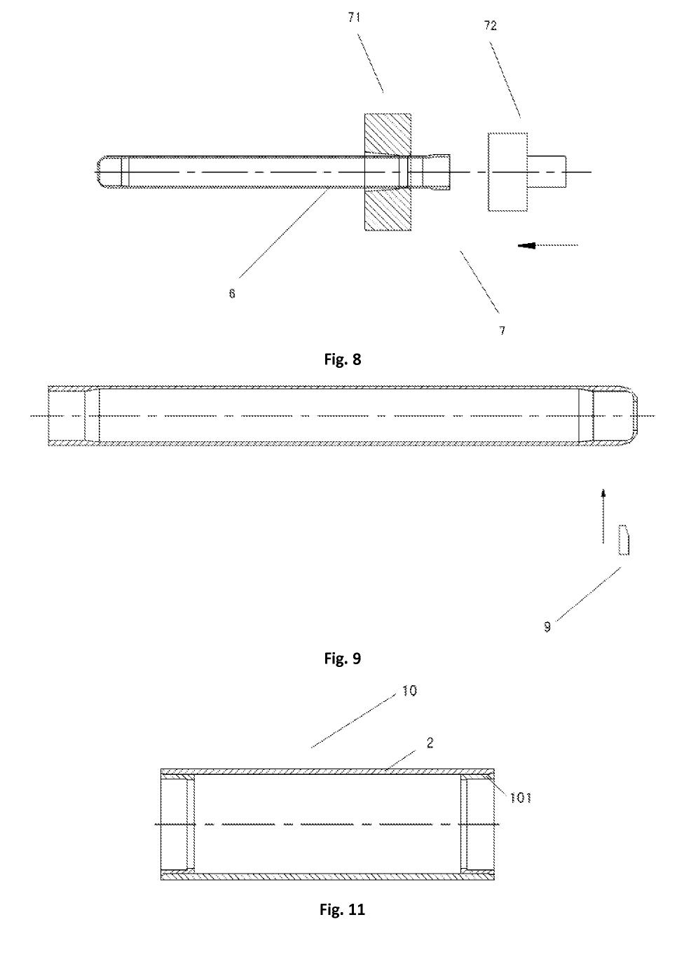

As shown in FIG. 8, a die for processing the tail end 7 may be used to process the tail end 61 of the drawn product 6 in FIG. 7. Firstly, the drawn product 6 in FIG. 7 passes through a die for extruding the tail end 71 which has an internal hole sized slightly greater than the outer diameter of the steel pipe 2, and then the tail end 61 of the drawn product 6 is extruded by an die for extruding 72 and processed into the form as shown in FIG. 9.

Referring to FIG. 9, a pipe cutting tool 9, a turning tool or the similar tools may be used to cut the arc section of the steel pipe 2, so as to process the steel pipe 2 into the roller with the shape as shown in FIG. 1.

A method of manufacturing the roller as shown in FIG. 1 has been described above; moreover, the method of direct forging can also be applied so as to directly manufacture the roller as shown in FIG. 1.

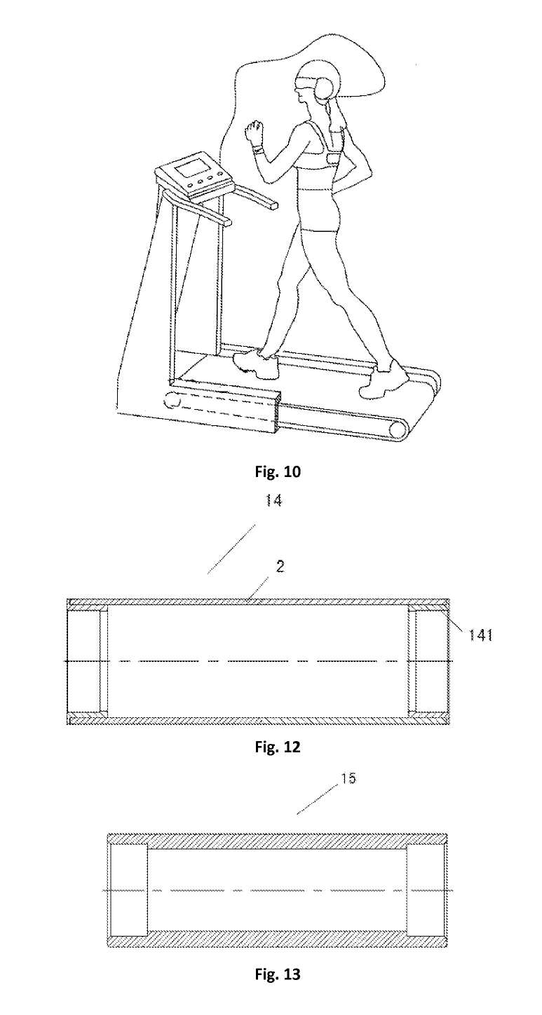

Referring to FIG. 10, a treadmill is shown that utilizes the aforementioned roller.

The above integrally structured roller 1 can serve as a transmission member and can be widely used in mechanical transmission, e.g., serving as the transmission member of a treadmill and producing outstanding transmission effect.

In the case where there is no steel sleeve used or there is necessity of increasing wall thickness for machining bearing bores, a roller according to the claimed invention may obtain a strength the same as the strength where a steel sleeve is used without increasing the pipe wall thickness. The roller of the present disclosure provides a simple structure, lower cost, and a service life longer than a roller with steel sleeves. Moreover, since the end portions are of high strength due to the integral structure, the ends thereof are not easily deformed.

While specific embodiments and applications of various embodiments have been illustrated and described, it is to be understood that the invention claimed hereinafter is not limited to the precise configuration and components disclosed. Various modifications, changes, and variations apparent to those of skill in the art may be made in the arrangement, operation, and details of the methods and systems disclosed.

What is claimed is:

1. A roller that is integrally structured, wherein a pipe wall thickness at an intermediate portion thereof is less than a pipe wall thickness at an end portion thereof, and towards the end portion, a pipe wall size at the intermediate portion transits into a pipe wall size at the end portion.

2. The roller according to claim 1, wherein the pipe wall thickness has an evenness of ±0.03 mm and a straightness less than or equal to 0.08 mm, and the outer diameter of the pipe wall has an ellipticity of ±0.015 mm.

3. The roller according to claim 2, wherein the pipe wall thickness has an evenness of ±0.01 mm and a straightness of 0.05, and the outer diameter has an ellipticity of ±0.005 mm.

4. The roller according to claim 1, wherein a transition section where pipe wall thickness size at the intermediate portion transits towards the end portion into pipe wall thickness size at the end portion is in a conical shape.

5. The roller according to claim 1, wherein a transition section where the pipe wall thickness size at the intermediate portion transits towards the end portion into the pipe wall thickness size at the end portion is in an arc shape.

6. A method for using the roller of claim 1, comprising using the roller as a transmission member.

7. The method according to claim 6, wherein using the roller as a transmission member comprises using the roller as a transmission member for a treadmill.

8. A treadmill comprising a roller, a roller power input means, a movement transmission means, and a frame body, wherein the roller is integrally structured and has a pipe wall thickness at an intermediate portion that is less than a pipe wall thickness at an end portion, and towards the end portion, pipe wall size at the intermediate portion is transited into a pipe wall size at the end portion.

9. The treadmill according to claim 8, wherein the pipe wall thickness has an evenness of ±0.03 mm and a straightness less than or equal to 0.08 mm, and the outer diameter of the pipe wall has an ellipticity of ±0.015 mm.

10. The treadmill according to claim 9, wherein the pipe wall thickness has an evenness of ±0.01 mm and a straightness of 0.05, and the outer diameter has an ellipticity of ±0.005 mm.
